(19) United States
(12) Patent Application Publication
(10) Pub. No.: US 2026/0180913 A1
(43) Pub. Date: Jun. 25, 2026

(54) METHOD FOR HANDLING REQUESTS ON BUS PROTOCOL BUFFERS WITHIN A NETWORK SWITCH

(71) Applicant: International Business Machines Corporation, Armonk, NY (US)

(72) Inventors: Aditi Desai, Poughkeepsie, NY (US); Michael James Becht, Poughkeepsie, NY (US); Luke Hopkins, Peterborough, NH (US)

(73) Assignee: International Business Machines Corporation, Armonk, NY (US)

(21) Appl. No.: 18/991,915

(22) Filed: Dec. 23, 2024

(51) Int. Cl. H04L 47/32; H04L 12/40; H04L 47/30

(52) U.S. Cl. CPC H04L 47/32; H04L 12/4013; H04L 47/30

(57) ABSTRACT

A method for recovering requests on bus protocol buffers within a network switch without disturbing data flow is disclosed. A register with multiple entries is provided within a network switch. Each entry of the register includes a LCHID. The entries of the LCHIDs within the register that need recovery can be set, for example, via a mask. A request in the network switch includes a source ID field for storing LCHID information of the request. After converting the request's LCHID information to a “one-hot” format, the request's LCHID information is then compared to the entries of LCHIDs within the register. The request is marked as a bad LCHID request if there is a match, and recovery will be suppressed for a Denied Response that is sent to a controller within the network switch. The bad LCHID request will then be cleaned up while allowing other requests to go to their respective destinations such that data flow of the network switch is not disturbed.

### STATEMENT REGARDING PRIOR DISCLOSURES BY THE INVENTOR OR A JOINT INVENTOR

Applicant is aware of certain confidential activities provided to third parties which may constitute a disclosure or offer for sale and which occurred within one year prior to the effective filing date of this application.

### BACKGROUND OF THE INVENTION

The present invention relates to network switches in general, and in particular, to a method and apparatus for handling requests on bus protocol buffers within a network switch.

A network switch is a device in a computer network that connects various devices together. Network switches manage the flow of data across a network by transmitting a received network packet only to the one or more devices for which the packet is intended. Each network device connected to a network switch can be identified by its network address, allowing the network switch to direct the flow of network traffic.

Data to be passed by network switches are generally divided into a series of packets that can be transmitted between devices. Packets include control information and payload data. The control information includes information used to deliver the payload data. For example, control information can include source and destination network addresses, error detection codes, packet sequencing identification, etc. Typically, control information is found in packet headers and trailers included within a packet and adjacent to the payload data.

Typically, in order to recover a bad request from bus protocol buffers within a network switch, the data flow of the network switch has to be disrupted, which may negatively affect the efficiency of the network switch.

Consequently, it would be desirable to provide a method for recovering bad requests on bus protocol buffers without disturbing data flow of a network switch.

### SUMMARY

In accordance with one embodiment of the present invention, a register with multiple entries is provided within a network switch. Each entry of the register includes a logical channel identifier (LCHID). The entries of the LCHIDs within the register that need recovery can be set, for example, via a mask. A request in the network switch includes a source ID field for storing LCHID information of the request. After converting the request's LCHID information to a “one-hot” format, the request's LCHID information is then compared to the entries of LCHIDs within the register. The request is marked as a bad request if there is a match, and recovery will be suppressed for a Denied Response that is sent to a controller within the network switch. The bad request will then be cleaned up while allowing other requests to go to their respective destinations such that data flow of the network switch is not disturbed.

### BRIEF DESCRIPTION OF THE DRAWINGS

FIG. 1 is a block diagram of a network switch in which one embodiment of the present invention can be incorporated;

FIG. 2 is a block diagram of a bus protocol design for the network switch from FIG. 1, according to one embodiment of the present invention;

FIG. 3A is a block diagram of two registers and a request within the network switch from FIG. 1, according to one embodiment of the present invention;

FIG. 3B is a logic diagram showing how to mark bad requests within the network switch from FIG. 1, according to one embodiment of the present invention;

FIG. 4A is a flowchart of a method for handling data on bus protocol buffers within a network switch without disturbing data flow, according to one embodiment of the present invention;

FIG. 4B is a state machine of a method for handling data on bus protocol buffers within a network switch without disturbing data flow, according to one embodiment of the present invention; and

FIG. 5 is a block diagram of a computing environment in which an embodiment of present invention can be incorporated.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION

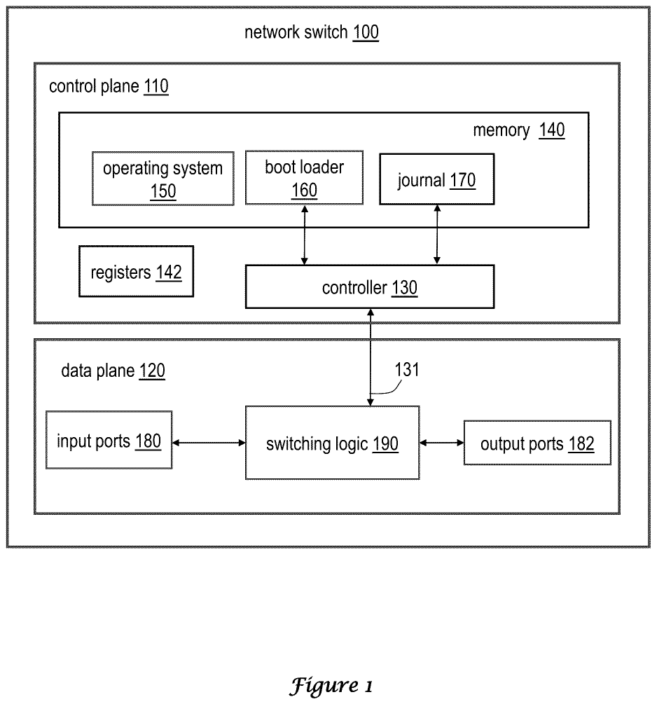

Referring now to the drawings, and in particular to FIG. 1, there is illustrated a block diagram of a network switch in which one embodiment of the present invention can be incorporated. As shown, a network switch 100 includes a control plane 110 and a data plane 120. Control plane 110 is a management layer for configuring, updating, and controlling data plane 120. Control plane 110 includes a controller 130, a memory 140 and a set of registers 142. Controller 130 can be a processor, microcontroller, or any hardware logic that can execute a boot loader program. Memory 140 can be a read-only memory (ROM), a random-access memory (RAM), and/or a flash memory. Memory 140 is utilized to store an operating system 150 and a boot loader 160. Boot loader 160 is a first program executed after a reboot of controller 130 and can run basic hardware tests before booting up operating system 150. Memory 140 also includes a journal 170 that can store state information related to configuration of data plane 120. Although a single memory is shown in FIG. 1, memory 140 can be divided into multiple memories. For example, boot loader 160 can be stored in a ROM, while journal 170 can be stored in a RAM.

Controller 130 has access to memory 140. In addition, controller 130 can communicate with data plane 120 via a communications bus 131. Communications bus 131 can be any bus type, such as PCI, PCIe, AGP, etc. Data plane 120 includes input ports 180 and output ports 182 for receiving and sending network packets, respectively. Switching logic 190 is positioned between input ports 180 and output ports 182. Switching logic 190 includes hardware for switching in accordance with layer 2, layer 3 or both.

After a reboot of network switch 100, controller 130 retrieves and executes boot loader 160. By using boot loader 160, controller 130 can establish communications over bus 131. In addition, controller 130 retrieves configuration information from journal 170. The configuration information may include configuration data and state information to indicate a state of any configuration updates, such as whether the updates are completed or not completed. As such, journal 170 allows boot loader 160 to determine a state of any configuration updates and then to continue with the configuration updates over bus 131. Boot loader 160 configures switching logic 190 prior to operating system 150 being loaded. Once operational, switching logic 190 can begin transmitting packets from input ports 180 to output ports 182. Boot loader 160 can then continue with loading operating system 150 to allow network switch 100 to become fully operational, including using routing protocols.

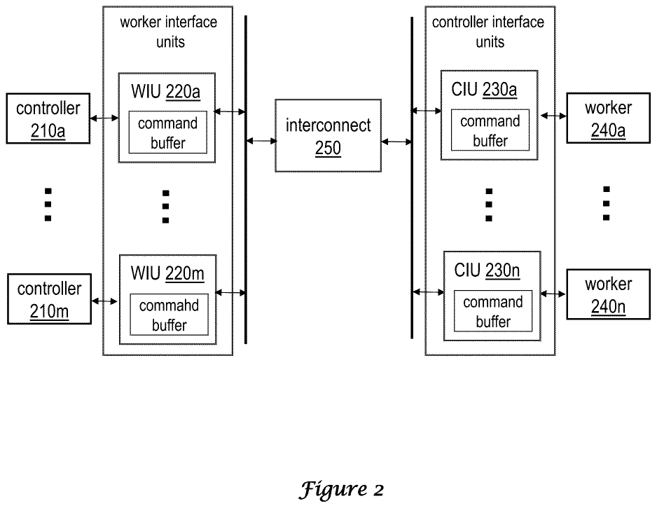

With reference now to FIG. 2, there is illustrated a block diagram of a bus protocol design, according to one embodiment of the present invention. Controllers 210a-210m want to send requests to workers 240a-240n. As shown, the bus protocol connects each of controllers 210a-210m to a corresponding one of worker interface units (WIUs) 220a-220m that handles a request receiving protocol. Each of WIUs 220a-220m includes a command buffer for holding requests. The requests from WIUs 220a-220m proceed to an interconnect 250 to allow requests to go to the same worker (destination) via arbitration. Interconnect 250 may be a crossbar or other type of connectors that are well-known in the art. The request selected in arbitration reaches to one of controller interface units (CIUs) 230a-230n. Each of CIUs 230a-230n includes a command buffer for holding requests. Each of workers 240a-240n is connected to a corresponding one of CIUs 230a-230n.

The bus protocol design in FIG. 2 can handle burst requests and immediate response requests. As soon as an immediate response request is received, the bus protocol sends a “done reply” message to the appropriate one of controllers 210a-210m while the actual request proceeds towards workers 240a-240n.

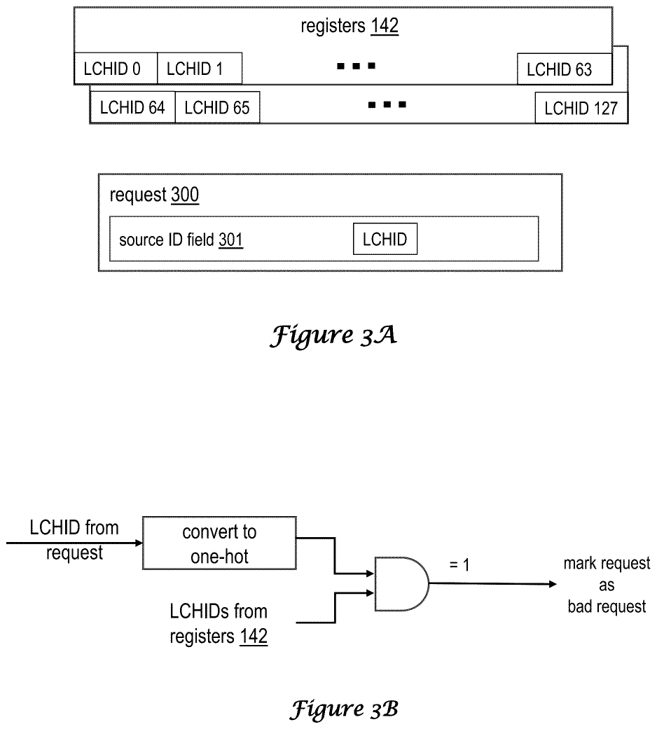

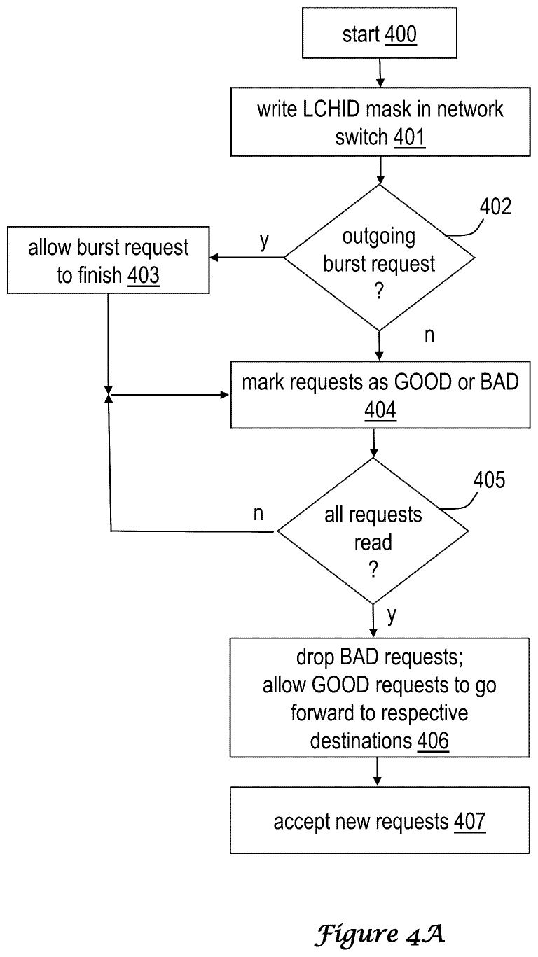

Registers 142 in network switch 100 (from FIG. 1) have multiple entries, and each entry can store one logical channel identifier (LCHID). For the present embodiment, there are 128 LCHIDs, and each bit within two 64-bit registers 142 represents one of the 128 LCHIDs. As shown in FIG. 3A, one of two registers 142 stores LCHID 0 to LCHID 63, and the other one stores LCHID 64 to LCHID 127. The entries within registers 142 can be dynamically set by, for example, firmware via an LCHID mask, regarding the LCHID(s) that needs recovery. Multiple entries within registers 142 can be set at the same time. They can be known as “data recovery IDs” and can be utilized to clean up entries within the command buffers of WIUs 220a-220m and/or the command buffers of CIUs 230a-230n.

Each request within network switch 100 comes with a source ID field. For example, a request 301 in FIG. 3A includes a source ID field 301. Some of the bits in source ID field 301 of request 301 are utilized to store LCHID information.

During operation, the LCHID in the source ID field of each request in the command buffer is compared to the LCHID entries within registers 142 in order to find out if the request has a bad LCHID. Such comparison can be performed by software, firmware, or hardware. For a hardware implementation example, each request's LCHID information is converted to a “one-hot” format and is then compared to the 128 LCHID entries in registers 142, and any request with a match with one of the 128 LCHID entries in registers 142 will be marked as a bad (LCHID) request, as shown in FIG. 3b.

Specifically, the data recovery IDs within registers 142 are compared to the entries (requests) within the command buffers of WIUs 220a-220m and/or the command buffers of CIUs 230a-230n. If there is a match, then the entry (request) will be cleaned up while the remaining entries (requests) are allowed to go to their respective destinations. A bit in a source ID field 301 is set and sent as part of a Denied Response so that even posted writes can recover. Recovery can take place in the command buffers of WIUs 220a-220m and/or in the command buffers of CIUs 230a-230n. This method is utilized to enable recovery for multiple requests at the same time.

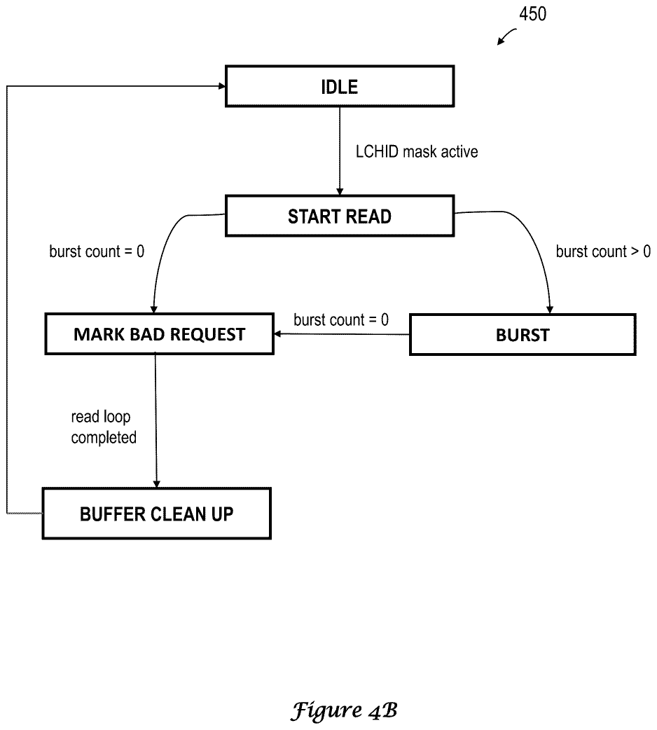

With reference now to FIG. 4A, there is illustrated a flowchart of a method for recovering requests on bus protocol buffers within a network switch without disturbing data flow, according to one embodiment of the present invention. Starting at 400, an LCHID mask is written in a network switch, as shown in block 410. The LCHID mask can be written in the network switch by, for example, firmware. At this point, the network switch stops from receiving new requests. A determination is made whether or not there is any current outgoing burst request in progress within the network switch, as depicted in block 402. If there is an outgoing burst request in progress (i.e., burst count>0), then the outgoing burst request is allowed to continue to finish, as shown in block 403. After the outgoing burst request has been completed, the process proceeds to block 404.

If there is no outgoing burst request in progress (i.e., burst count=0), then all the requests in the network switch are read one by one, and each request is marked as either GOOD (i.e., good request) or BAD (i.e., bad request), as depicted in block 404. A bit in the source ID field of a request is utilized for a controller to identity the Denied Response with an act of recovery procedure, which also enables the controller to identify a double response for BAD marked posted write request. There are two types of Denied Response information in the source ID field of a request to provide to the controller: Type I (for example, bit=0) informs the controller to initiate a recovery process, and Type II (for example, bit=1) informs the controller to suppress the initiation of recovery. Since purging is part of an ongoing recovery process, Type II is needed to suppress the controller's initiation of recovery when performing the cleanup (purge) action as described in the present disclosure, and the recovery will be delegated to the process that has initiated the purge. A Denied Response is immediately sent for a request that has been marked as BAD.

Next, a determination is made whether or not all the requests have been read, as depicted in block 405. If there are requests that have not been read, the process returns to block 404. Otherwise, if all the requests have been read, requests that were marked as BAD are dropped, while requests that were marked as GOOD are forwarded to their respective destinations, as depicted in block 406. Afterwards, the network switch can start accepting requests again, as shown in block 407.

The method depicted in FIG. 4A can be implemented via a state machine. With reference now to FIG. 4B, there is illustrated a state machine of a method for recovering requests on bus protocol buffers within a network switch without disturbing data flow, according to one embodiment of the present invention. As shown, a state machine 450 includes five states, namely, an IDLE state, a START READ state. a BURST state, a MARK BAD REQUEST state, and a BUFFER CLEAN UP state. State machine 450 can be stored within a network switch, such as network switch 100 from FIG. 1.

At the START READ state, the network switch stops accepting any new request. The network switch also checks to see if there is any current outgoing burst request in progress. If there is no current outgoing burst request in progress (i.e., burst count=0), then the state machine moves to the MARK BAD REQUEST state. If there is a current outgoing burst request in progress (i.e., burst count>0), then the state machine moves to the BURST state.

At the BURST state, the current outgoing burst request is allowed to continue to finish in the BURST state. After finishing sending the current outgoing burst request, the state machine moves to the MARK BAD REQUEST state because there is no more outgoing burst request in progress (i.e., burst count=0).

At the MARK BAD REQUEST state, each of the requests within the network switch is read and marked as either GOOD or BAD. After all the requests have been read and marked, the state machine moves to the BUFFER CLEAN UP state.

At the BUFFER CLEAN UP state, requests that were marked as BAD are dropped, while requests that were marked as GOOD are forwarded to their respective destinations. A Denied Response is immediately sent for a request that has been marked as BAD. After all the requests have been processed, the state machine moves to the IDLE state, and the network switch can start accepting requests again.

As has been described, the present invention provides a method and apparatus for recovering requests on bus protocol buffers within a network switch without disturbing data flow.

Data recovery is selectively performed in a bus protocol environment while active data/request transactions are going on. Data to be recovered is set dynamically by firmware. Data can be selectively removed from a bus, and rest of the data transaction continues as normal. Each request removed from the bus gets a Denied Response sent back to the originator of the request with a bit set in a source ID field so the controller can identify the Denied Response as part of recovery even for posted write request. The entire process takes care of the bus protocol environment.

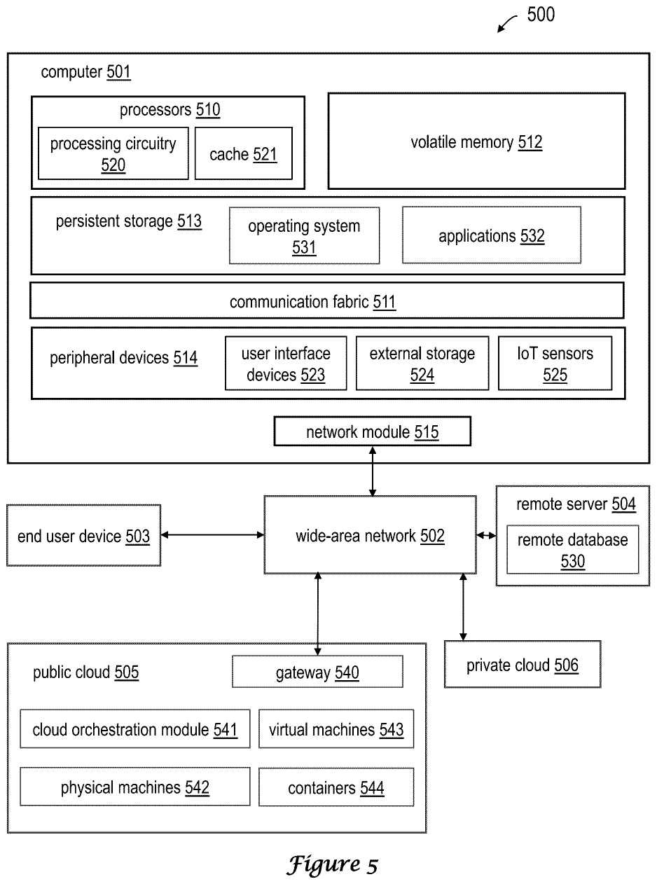

Referring now to FIG. 5, there is illustrated a block diagram of a computing environment in which an embodiment of present invention can be executed. As shown, a computing environment 500 contains an example of an environment for the execution of at least some of the computer code involved in performing the inventive methods, such as a method for recovering data on bus protocol buffers within a network switch without disturbing data flow via code of one of applications 532. Computing environment 500 also includes, for example, computer 501, wide-area network (WAN) 502, end user device (EUD) 503, remote server 504, public cloud 505, and private cloud 506. In this embodiment, computer 501 includes processor 510 having processing circuitry 520 and cache 521, communication fabric 511, volatile memory 512, persistent storage 513 (including operating system 531 and applications 532), peripheral devices 514 (including user interface devices 523, and Internet of Things (IoT) sensors 525), and network module 515. Public cloud 505 includes a gateway 540, a cloud orchestration module 541, physical machines 542, virtual machines 543, and containers 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud. On the other hand, computer 501 is not required to be in a cloud except to any extent as may be affirmatively indicated.

Processors 510 includes one or more processing elements of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processors 510. Cache memories are typically organized into multiple levels depending upon relative proximity to the processing circuitry. Alternatively, some, or all, of the cache for the processor set may be located off chip. In some computing environments, processors 510 may be designed for working with qubits and performing quantum computing.

Computer readable program instructions are typically loaded onto computer 501 to cause a series of operational steps to be performed by processors 510 of computer 501 and thereby effect a computer-implemented method, such that the instructions thus executed will instantiate the methods specified in flowcharts and/or narrative descriptions of computer-implemented methods included in this document (collectively referred to as the inventive methods). These computer readable program instructions are stored in various types of computer readable storage media, such as cache 521 and the other storage media discussed below. The program instructions, and associated data, are accessed by processors 510 to control and direct performance of the inventive methods. In computing environment 500, at least some of the instructions for performing the inventive methods may be stored as applications 532 within persistent storage 513.

Communication fabric 511 is the signal conduction paths that allow the various components of computer 501 to communicate with each other. This fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random-access memory (RAM) or static type RAM. Volatile memory 512 is characterized by random access, but this is not required unless affirmatively indicated. In computer 501, volatile memory 512 is located in a single package and is internal to computer 501, but, alternatively or additionally, volatile memory 512 may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read-only memory (ROM), but typically at least a portion of the persistent storage allows writing of data, deletion of data and re-writing of data. Some familiar forms of persistent storage include magnetic disks and solid state storage devices. Operating system 531 may take several forms, such as various known proprietary operating systems or open source Portable Operating System Interface type operating systems that employ a kernel. The code included in applications 532 includes at least some of the computer code involved in performing the inventive methods.

Peripheral devices 514 include the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) devices 523 may include components such as a display screen, speaker, microphone, wearable devices (such as goggles and smart watches), keyboard, mouse, printer, touchpad, game controllers, and haptic devices. External storage 524 can be an external hard drive, or insertable storage, such as an SD card. External storage 524 may be persistent and/or volatile. In some embodiments, external storage 524 may take the form of a quantum computing storage device for storing data in the form of qubits. In embodiments where computer 501 is required to have a large amount of storage (for example, where computer 501 locally stores and manages a large database), then this storage may be provided by peripheral storage devices designed for storing very large amounts of data, such as a storage area network (SAN) that is shared by multiple, geographically distributed computers. IoT sensors 525 are made up of sensors that can be used in Internet-of-Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or WiFi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can be downloaded to computer 501 from an external computer or external storage device through a network adapter card or network interface included within network module 515.

WAN 502 is any wide-area network (for example, the internet) capable of communicating computer data over non-local distances by any technology for communicating computer data, now known or to be developed in the future. In some embodiments, WAN 502 may be replaced and/or supplemented by local-area networks (LANs) designed to communicate data between devices located in a local area, such as a WiFi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 115 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from a remote database of a remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machines 542, which is the universe of physical computers in and/or available to public cloud 505. Virtual computing environments (VCEs) typically take the form of virtual machines from virtual machines 543 and/or containers from containers 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is a collection of computer software, hardware, and firmware that allows public cloud 505 to communicate through WAN 502.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the invention has been particularly shown and described with reference to a preferred embodiment, it will be understood by those skilled in the art that various changes in form and detail may be made therein without departing from the spirit and scope of the invention.

What is claimed is:

1. A computer-implemented method comprising:
providing a register within a network switch, wherein said register includes a plurality of entries, and at least one of said entries includes a LCHID;
setting entries of said LCHIDs within said register that need recovery;
comparing LCHID information in a source ID field of a request within said network switch to said LCHIDs within said register;
marking said request as a bad request if there is a match or as a good request if there is a mismatch; and
cleaning said bad request while allowing other requests to go to their respective destinations such that data flow of said network switch is not disturbed.

2. The method of claim 1, wherein said setting further includes setting entries of said LCHIDs within said register that need recovery via a mask.

3. The method of claim 1, wherein said setting is performed by firmware.

4. The method of claim 1, wherein said setting further includes preventing said network switch from receiving new requests.

5. The method of claim 1, further comprising suppressing recovery in a Denied Response that is sent to a controller within said network switch.

6. The method of claim 4, wherein said suppressing is denoted by a bit in said source ID field of said request to be utilized by a controller to suppress recovery procedure for said Denied Response.

7. The method of claim 1, wherein said marking is performed by hardware or firmware.

8. The method of claim 1, wherein comparing further includes converting said LCHID information in said source ID field of said request to an “one-hot” format.

9. The method of claim 1, wherein said cleaning further includes dropping said bad request.

10. The method of claim 1, wherein said cleaning further includes allowing said network switch to receive new requests.

11. A computer program product for recovering requests on bus protocol buffers within a network switch without disturbing data flow, said computer program product comprising a computer readable storage medium having program instructions embodied therein, said program instructions executable by a computer to cause said computer to perform:
providing a register within a network switch, wherein said register includes a plurality of entries, and at least one of said entries includes a LCHID;
setting entries of said LCHIDs within said register that need recovery;
comparing LCHID information in a source ID field of a request within said network switch to said LCHIDs within said register;
marking said request as a bad request if there is a match or as a good request if there is a mismatch; and
cleaning said bad request while allowing other requests to go to their respective destinations such that data flow of said network switch is not disturbed.

12. The computer program product of claim 11, wherein said setting further includes setting entries of said LCHIDs within said register that need recovery via a mask.

13. The computer program product of claim 11, wherein said setting is performed by firmware.

14. The computer program product of claim 11, wherein said setting further includes preventing said network switch from receiving new requests.

15. The computer program product of claim 11, further comprising suppressing recovery in a Denied Response that is sent to a controller within said network switch.

16. The computer program product of claim 15, wherein said suppressing is denoted by a bit in said source ID field of said request to be utilized by a controller to suppress recovery procedure for said Denied Response.

17. The computer program product of claim 11, wherein said marking is performed by hardware or firmware.

18. The computer program product of claim 11, wherein comparing further includes converting said LCHID information in said source ID field of said request to an “one-hot” format.

19. The computer program product of claim 11, wherein said cleaning further includes dropping said bad request.

20. The computer program product of claim 11, wherein said cleaning further includes allowing said network switch to receive new requests.
